(19) United States
(12) Patent Application Publication
(10) Pub. No.: US 2026/0149005 A1
(43) Pub. Date: May 28, 2026

(54) FUEL CELL

(71) Applicant: SUBARU CORPORATION, Tokyo (JP)

(72) Inventor: Michita YANAGITA, Tokyo (JP)

(21) Appl. No.: 19/373,323

(22) Filed: Oct. 29, 2025

(30) Foreign Application Priority Data
Nov. 22, 2024 (JP) 2024-203949

(51) Int. Cl. H01M 4/86; H01M 4/88; H01M 4/90; H01M 8/0254; H01M 8/1006

(52) U.S. Cl. CPC H01M 4/8642; H01M 4/8807; H01M 4/9041; H01M 8/0254; H01M 8/1006; H01M 2250/20

(57) ABSTRACT

A fuel cell includes a membrane electrode assembly and a separator. In the membrane electrode assembly, an electrolyte membrane is sandwiched between catalyst layers. The separator includes ribs that are in contact with the membrane electrode assembly and a passage that is provided between the ribs and configured to circulate a gas supplied to the electrolyte membrane. In an in-plane direction of the catalyst layers, an amount of a catalyst metal contained in the catalyst layers is larger in an under-passage region located immediately below the passage than in an under-rib region located immediately below the ribs.

### CROSS-REFERENCE TO RELATED APPLICATIONS

The present application claims priority from Japanese Patent Application No. 2024-203949 filed on Nov. 22, 2024, the entire contents of which are hereby incorporated by reference.

### BACKGROUND

The disclosure relates to a fuel cell to be applied to, for example, a fuel cell vehicle.

### RELATED ART

In a system using a fuel cell, a hydrogen gas is supplied to one electrode (fuel electrode) and an oxygen gas is supplied to the other electrode (air electrode). By reactions thereof, electric energy is obtained. Such a system can be mounted on a movable body, for example. As an example of the movable body, a fuel cell vehicle can be exemplified.

The fuel cell vehicle is mounted with, for example, about several hundred unit cells (fuel cells) that are divided via separators and stacked as fuel cell stacks. An anode gas and a cathode gas flow into the fuel cell via a passage provided in a separator or the like. Such a fuel cell employs a structure in which a known electrolyte layer is interposed between a catalyst layer and a gas diffusion layer (GDL).

### SUMMARY

An aspect of the disclosure provides a fuel cell. The fuel cell includes a membrane electrode assembly and a separator. In the membrane electrode assembly, an electrolyte membrane is sandwiched between catalyst layers. The separator includes ribs that are in contact with the membrane electrode assembly and a passage that is provided between the ribs and configured to circulate a gas supplied to the electrolyte membrane. In an in-plane direction of the catalyst layers, an amount of a catalyst metal contained in the catalyst layers is larger in an under-passage region located immediately below the passage than in an under-rib region located immediately below the ribs.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1A is a functional block diagram of a fuel cell stack including stacked fuel cells according to an embodiment. FIG. 1B is a fuel cell vehicle (an example of a movable body) on which the fuel cell stack is mounted.

FIG. 2 is a schematic diagram illustrating elements of a fuel cell according to the embodiment.

FIG. 3 is a schematic diagram illustrating a membrane electrode assembly of the fuel cell according to the embodiment.

FIG. 4 is a cross-sectional view schematically illustrating a cross section of the fuel cell according to the embodiment.

FIG. 5 is an enlarged view of an α portion in FIG. 4, and is a schematic diagram illustrating a distribution of the amount of a catalyst metal in an in-plane direction in a catalyst layer.

FIG. 6 is a schematic diagram illustrating a manufacturing method (an example) of a catalyst layer in the fuel cell according to the embodiment.

FIG. 7 is a cross-sectional view illustrating a part of a fuel cell according to an embodiment, and is a schematic diagram illustrating a distribution of the amount of a catalyst metal in a thickness direction in a catalyst layer.

FIG. 8A is a schematic diagram illustrating a structure of a catalyst layer in a fuel cell according to an embodiment, and is a graph illustrating changes in a distance from an air electrode inlet and a catalyst supported amount. FIG. 8B is a schematic diagram illustrating a structure of a catalyst layer in a fuel cell according to the embodiment.

### DETAILED DESCRIPTION

For example, as disclosed in Japanese Unexamined Patent Application Publication (JP-A) No. 2007-242415 and JP-A No. 2009-187877, a function of a catalyst layer is also largely involved in power generation efficiency in a fuel cell. Improving an effective utilization rate of the catalyst is to enhance product competitiveness. For example, JP-A No. 2007-242415 proposes a structure in which a catalyst amount is changed continuously or stepwise in accordance with a distance in a cell in-plane direction from a rib edge of a separator.

There are problems with current technology, not limited to the patent literatures described above. That is, in the structure disclosed in JP-A No. 2007-242415, water (generated water) generated by power generation stays at rib end portions and hinders gas diffusion, and as a result, diffusion of oxygen is hindered at the air electrode side, which may cause a failure to maintain power generation performance. In other words, the power generation efficiency is low in a region of the catalyst layer below the rib of the separator, and a catalyst metal existing below the rib does not necessarily contribute to effective power generation.

It is desirable to provide a fuel cell capable of reducing the waste of a catalyst metal in a catalyst layer of a fuel cell and improving power generation efficiency with respect to the amount of the catalyst metal.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Configurations other than those described in detail below may be appropriately supplemented with elemental technologies and configurations relating to known fuel cells and fuel cell vehicles including those disclosed in the above-described patent literatures.

### First Embodiment

A first embodiment of the disclosure will be described.

### Fuel Cell Vehicle 300

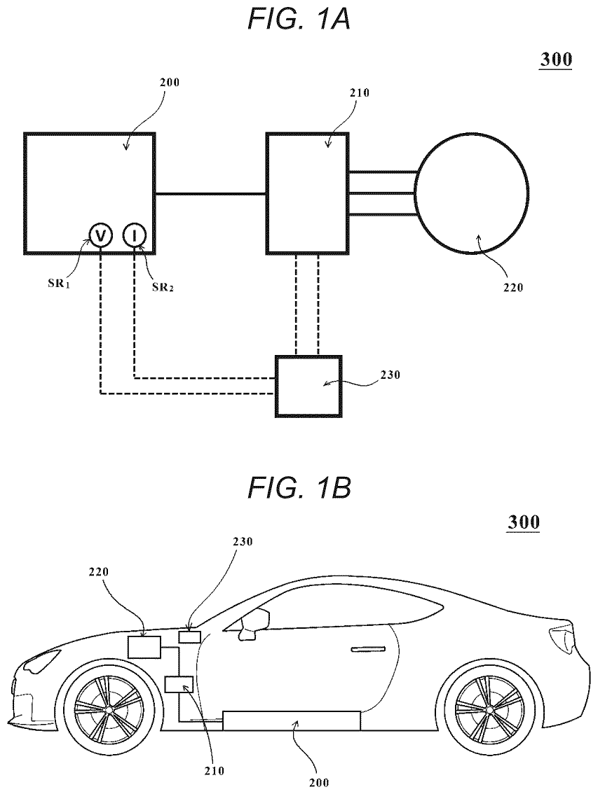

A configuration of a fuel cell vehicle 300 as an example of a movable body in the disclosure will be described with reference to FIGS. 1A and 1B. As illustrated in FIGS. 1A and 1B, the fuel cell vehicle 300 in the first embodiment may include a fuel cell stack 200, an inverter 210, a load 220, a control device 230, and the like. In the fuel cell vehicle 300, under control of the control device 230, electric power generated in the fuel cell stack 200 is supplied to the load 220 via the known inverter 210. The fuel cell vehicle 300 in the embodiment includes, for example, various known devices (not illustrated) mounted on the fuel cell vehicle, such as a hydrogen tank, a gas supply mechanism (anode gas supply device, cathode gas supply device), a coolant supply device, and a DC/DC converter.

The fuel cell stack 200 includes several tens of to several hundred fuel cells 100 as unit cells, which will be described later, stacked in a stacking direction, for example. Each of the fuel cells 100 has a function of generating electric power by causing an anode gas AG (also referred to as a fuel gas or hydrogen gas) as a reaction gas to react with a cathode gas CG (oxygen in the air, also referred to as an oxidant gas).

The fuel cell stack 200 may include a known voltage sensor SR₁ capable of measuring a voltage applied to the fuel cell stack, a voltage of each fuel cell 100, or the like, and a known current sensor SR₂ capable of measuring a current flowing through the fuel cell 100. The fuel cell 100 is not particularly limited insofar as the gist of the disclosure is not departed from, and a known polymer electrolyte fuel cell (PEFC) or the like is suitable.

The inverter 210 has a function of converting DC power generated in the fuel cell stack 200, for example, into AC power suitable for driving an electric motor that is the load 220. The inverter 210 performs, for example, frequency control in accordance with an accelerator opening degree of the fuel cell vehicle 300. As the inverter 210, there is no particular limitation insofar as the inverter 210 fulfills the above function, and for example, various known inverters including a three-phase bridge circuit can be applied.

The load 220 includes, for example, a known electric motor capable of outputting power for driving drive wheels (not illustrated) of the fuel cell vehicle 300. In the embodiment, an electric motor configured to generate power to be used by the drive wheels is exemplified as an example of the load 220. Alternatively, the load 220 may be another electric device mounted on the fuel cell vehicle 300. As an example, a known three-phase AC electric motor can be exemplified.

The control device 230 is an electronic control unit (ECU) mounted on the electric vehicle and includes a CPU as an arithmetic processing device, a ROM as a storage element configured to store a program, an arithmetic parameter, and the like used by the CPU, a RAM as a storage element configured to temporarily store various types of information, and the like. The control device 230 may further include a battery management unit (BMU) configured to monitor and control a state of the battery. The control device 230 may be configured to communicate with another known ECU mounted on the fuel cell vehicle 300 or various sensors (not illustrated).

Hereinafter, a fuel cell vehicle will be used as an example of a movable body. The disclosure is applicable to various known movable bodies that can be moved by mounting a fuel cell system as a drive source, such as a marine vessel, an aircraft, or a train. That is, the fuel cell stack 200 of the disclosure is applicable not only to fuel cell vehicles but also to other movable bodies such as a marine vessel and an aircraft.

### Fuel Cell 100

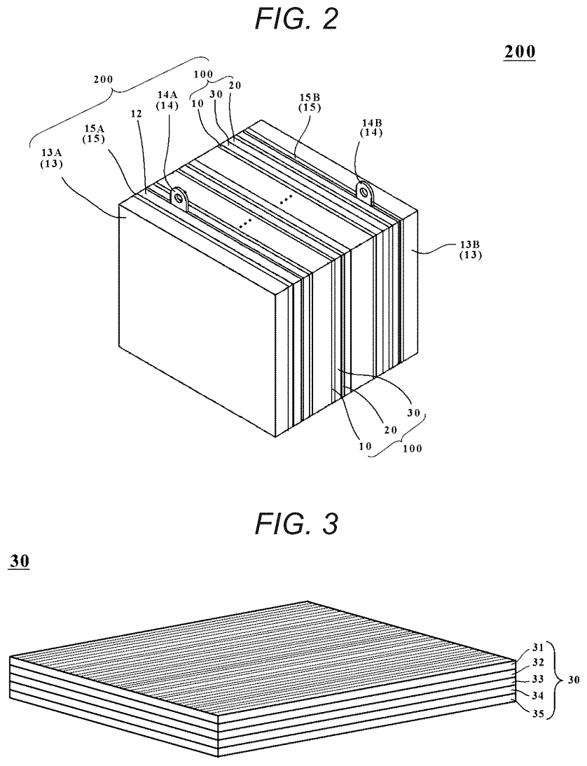

With reference to FIG. 2 as well, a configuration (an example) of the fuel cell 100 in the embodiment will be described. As illustrated in FIG. 2, the fuel cell 100 of the embodiment includes a membrane electrode assembly (MEA 30) sandwiched between an anode separator 10 and a cathode separator 20. The fuel cell stack 200 may include several tens of to several hundred sets of the anode separator 10, the cathode separator 20, and the MEA 30 that are stacked.

An example of the fuel cell stack 200 in the embodiment will be described. As illustrated in FIG. 2, in the fuel cell stack 200 of the embodiment, the fuel cells 100 are stacked, and a pair of current collector plates 14 (a first current collector plate 14A and a second current collector plate 14B) capable of extracting a current are disposed at both ends of the stacked fuel cells 100. As can be seen from FIG. 2, known insulating plates 15 (first insulating plate 15A and second insulating plate 15B) are provided on outer sides of the pair of current collector plates 14. A pair of end plates 13 (first end plate 13A and second end plate 13B) are provided on outer sides of the pair of insulating plates 15, and an appropriate predetermined load is applied to fuel cells 100 in the stacking direction by the pair of end plates 13 and known fastening bolts (not illustrated).

As illustrated in FIG. 2, as an example, a known pressure distribution measurement plate 12 capable of measuring an in-plane pressure distribution in the fuel cell 100 is interposed between the first end plate 13A and the first current collector plate 14A. As described, in the fuel cell stack 200 of the embodiment, the fuel cells 100 may be stacked, and the pressure distribution measurement plate 12 capable of measuring the in-plane pressure distribution in the fuel cell 100 may be interposed between the end plate 13 and the current collector plate 14.

The configuration of the fuel cell stack 200 illustrated in FIG. 2 is an example, and, for example, the pressure distribution measurement plate 12 may be omitted as appropriate, or a known configuration of the fuel cell stack may be applied in addition to the above.

As illustrated in FIG. 3, the MEA 30 is a membrane electrode assembly in which a pair of catalyst layers and a pair of gas diffusion layers sandwich an electrolyte layer. The MEA 30 of the embodiment is disposed between the anode separator 10 and the cathode separator 20. As illustrated in FIG. 3, the MEA 30 of the embodiment has a structure in which a cathode catalyst layer 32 and an anode catalyst layer 34 sandwich a known electrolyte layer 33.

An anode gas diffusion layer (anode GDL) 35 is provided opposite to the anode catalyst layer 34 from the electrolyte layer 33. A cathode gas diffusion layer (cathode GDL) 31 is provided opposite to the cathode catalyst layer 32 from the electrolyte layer 33. As an example, the cathode gas diffusion layer 31 may be provided with a porous plate also known as a metal porous body through which the cathode gas can circulate, a structural body in which a mesh-shaped metal plate also known as a three-dimensional fine mesh is superposed on carbon paper or carbon cloth, or a structural body in which a passage groove is provided in carbon paper.

### Distribution of Amount (Supported Amount) of Catalyst Metal in Catalyst Layer

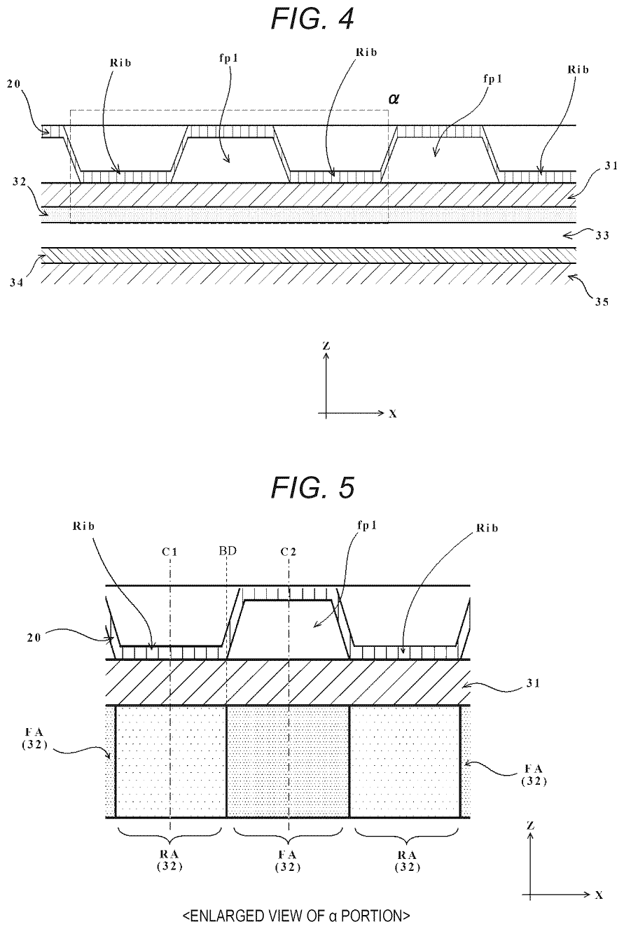

With reference to FIGS. 4 and 5 and the like, a distribution of the amount (supported amount) of a catalyst metal in the catalyst layer in the fuel cell 100 will be described. Hereinafter, the cathode catalyst layer 32 will be described as an example of the catalyst layer, and the anode catalyst layer 34 may be similarly applied.

In the cathode catalyst layer 32 in the embodiment, for example, a catalyst metal, such as platinum (Pt) nanoparticles or platinum-cobalt (Pt—Co) particles, is bonded to a catalyst support that is exemplified by a metal material, such as stainless steel or titanium, or a carbon material. The catalyst support supporting the catalyst metal in this manner is dispersed in the cathode catalyst layer 32, and the embodiment is mainly characterized in that the amount (supported amount) of the catalyst metal is different in an in-plane direction and a thickness direction of the cathode catalyst layer 32.

In one example, as illustrated in FIG. 4, the fuel cell 100 of the embodiment includes a membrane electrode assembly (MEA 30) in which the electrolyte layer 33 is sandwiched between catalyst layers (the cathode catalyst layer 32 and the anode catalyst layer 34). The fuel cell 100 of the embodiment includes the cathode separator 20. The cathode separator 20 includes ribs Rib in contact with the membrane electrode assembly, and a passage fp1 that is provided between the ribs Rib and through which a gas supplied to the electrolyte layer 33 can circulate.

As illustrated in FIG. 5, the amount of the catalyst metal contained in the cathode catalyst layer 32 is larger in an under-passage region FA located immediately below the passage fp1 than in an under-rib region RA located immediately below the rib Rib in the in-plane direction of the cathode catalyst layer 32 (X direction in which the passages fp1 are arranged side by side in FIG. 5).

The influence of oxygen diffusion, for example, causes a relatively low power generation output immediately below the ribs of the cathode separator 20 having the passage. At this time, the catalyst metal existing below the ribs in the cathode catalyst layer 32 relatively does not contribute to power generation. In other words, the catalyst metal located below the ribs is wasteful in terms of poor power generation efficiency, which may also contribute to an increase in production cost of the fuel cell.

Therefore, in the embodiment, the amount (supported amount) of the catalyst metal located in a region (for example, below the ribs) that does not greatly contribute to the improvement of the power generation efficiency is relatively small compared with those at other locations so that the power generation efficiency as a whole is not greatly reduced, and the amount of the catalyst metal is reduced to reduce the cost. In the embodiment, a region below the ribs of the separator is exemplified as the region that does not greatly contribute to the improvement of the power generation efficiency. Alternatively, for example, the technique of the embodiment may be applied to a region where the power generation efficiency decreases due to the influence of generated water or the like.

As illustrated in FIG. 5, FIG. 7 and the like used in a second embodiment, which will be described later, in the in-plane direction of the cathode catalyst layer 32, the amount of the catalyst metal contained in the cathode catalyst layer 32 may be increased stepwise such that a vicinity C1 in the center of the under-rib region RA has a lower limit value and a vicinity C2 in the center of the under-passage region FA has an upper limit value. As an example of the “stepwise increase” described above, the amount of the catalyst metal may be increased stepwise from the under-rib region RA to the under-passage region FA, or the amount of the catalyst metal may be increased linearly or curvedly.

In the example illustrated in FIG. 5, a boundary BD where the adjacent under-rib region RA and under-passage region FA are adjacent to each other is illustrated. The amount (supported amount) of the catalyst metal at this boundary BD may be an intermediate value of the amounts (supported amounts) of the catalyst metal in the under-rib region RA and the under-passage region FA. Further, the amount (supported amount) of the catalyst metal may be set to gradually increase in the in-plane direction from the under-rib region RA toward the under-passage region FA. In other words, in the in-plane direction of the cathode catalyst layer 32, the amount of the catalyst metal in a region located at the boundary between the under-rib region RA and the under-passage region FA may be smaller than the amount of the catalyst metal in the vicinity of the center of the under-passage region FA.

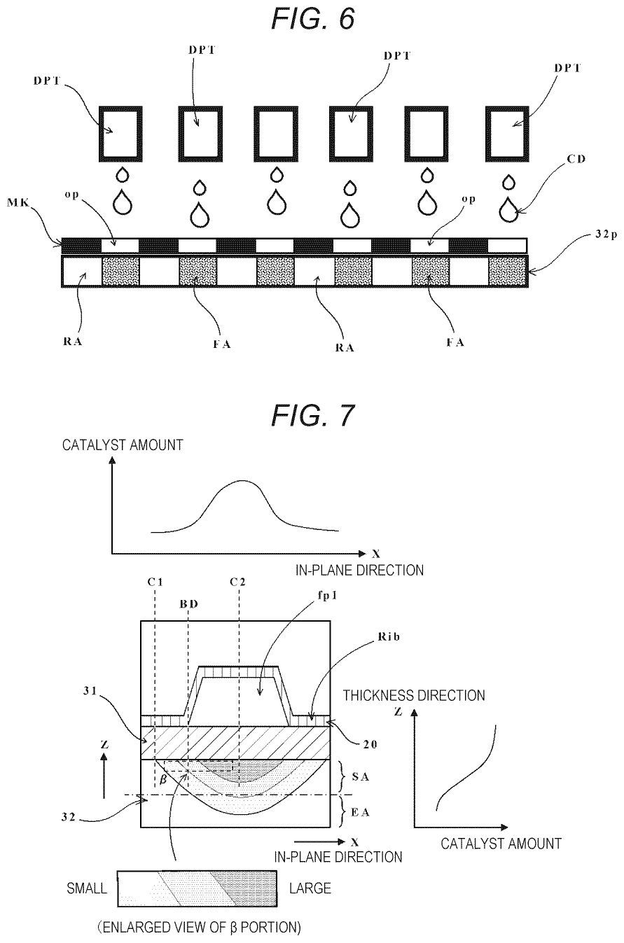

FIG. 6 illustrates an example of a manufacturing method of the cathode catalyst layer 32 in the embodiment.

As illustrated, in manufacturing the cathode catalyst layer 32, for example, a mask MK with openings op coats a base plate 32p as a base material. Then, multiple kinds of catalyst metal liquids CD (liquids in which catalyst metals are dispersed in a solvent) having different supported amounts may be discharged from a known discharge device DPT while appropriately shifting the mask MK so as to coat each area (the under-rib region RA and the under-passage region FA).

A technique of forming regions having different amounts (supported amounts) of catalyst metal in the cathode catalyst layer is not limited to the above-described example, and the above-described catalyst metal liquid may be applied by electric field control of a known electrostatic spray, or a known technique including those in the above-described patent literatures may be applied.

As described above, according to the fuel cell 100 of the first embodiment, the amount of the catalyst metal located in the under-rib region RA that hardly contributes to the power generation is decreased to eliminate the waste of the catalyst, whereby the ratio of the amount of the catalyst metal effective for the power generation is increased to improve the power generation efficiency with respect to the amount of the catalyst metal.

### Second Embodiment

The fuel cell 100 according to a second embodiment of the disclosure will be described with reference to FIG. 7. FIG. 7 illustrates a distribution of the amount of a catalyst metal in the thickness direction in the cathode catalyst layer 32 in the fuel cell 100. In the following second embodiment, points different from those of the first embodiment will be mainly described. Configurations that perform the same functions as those in the first embodiment are denoted with the same reference numerals, and a description thereof will be omitted as appropriate.

The amount of the catalyst metal in the cathode catalyst layer 32 of the first embodiment described above has a distribution in the in-plane direction (the X direction in which the passages are arranged side by side) such that the amount of the catalyst metal in the under-passage region FA is larger than that in the under-rib region RA. On the other hand, the amount of the catalyst metal in the cathode catalyst layer 32 of the second embodiment is mainly characterized in that the amount of the catalyst metal has a distribution in the thickness direction (Z direction).

In one example, as can be seen from FIG. 7, the amount of the catalyst metal in the cathode catalyst layer 32 in the embodiment is larger in a separator side region SA closer to the cathode separator 20 than in an electrolyte membrane side region EA closer to the electrolyte layer 33 in the thickness direction (Z direction) of the cathode catalyst layer 32.

As illustrated in FIG. 7, the amount of the catalyst metal in the cathode catalyst layer 32 may decrease stepwise from the separator side region SA to the electrolyte membrane side region EA in the thickness direction (Z direction) of the cathode catalyst layer 32 in a manner of spreading radially from the vicinity C2 of the center of the under-passage region FA.

As illustrated in an enlarged view of a β portion, the amount of the catalyst metal in the cathode catalyst layer 32 may increase stepwise from the under-rib region RA to the under-passage region FA and decrease stepwise from the separator side region SA to the electrolyte membrane side region EA in a manner of spreading radially from the vicinity C2 of the center of the under-passage region FA.

As described above, also in the fuel cell 100 of the second embodiment, effects similar to those of the fuel cell 100 of the first embodiment can be achieved. As an example, the cathode catalyst layer 32 in the second embodiment can be manufactured by stacking the base plate 32p serving as the base material in the thickness direction, disposing the mask MK at a position suitable for each layer, and controlling a discharge amount of the catalyst metal liquid from the electrostatic spray.

### Third Embodiment

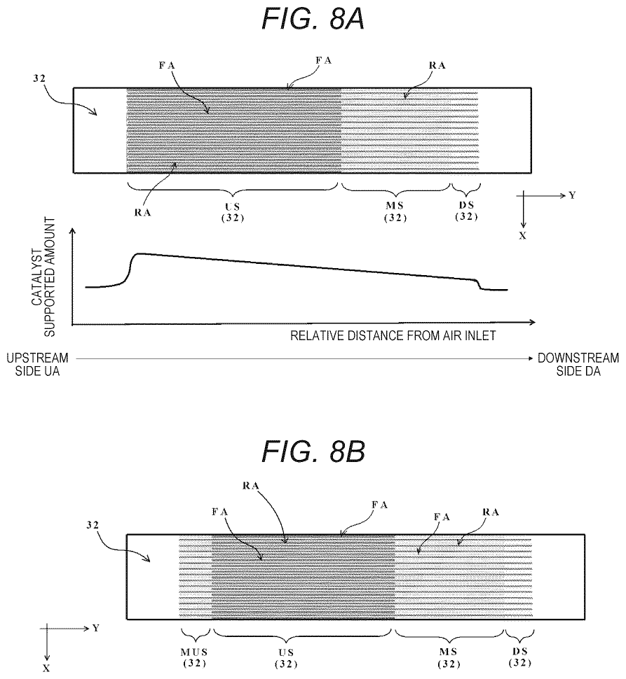

The fuel cell 100 according to a third embodiment of the disclosure will be described with reference to FIGS. 8A and 8B. FIG. 8A illustrates a distribution of the amount of a catalyst metal in a circulation direction from upstream to downstream in the cathode catalyst layer 32 in the fuel cell 100. Also in the third embodiment described below, points different from the above-described embodiments will be mainly described.

The cathode separator 20 with a passage is provided on an outer side of the cathode catalyst layer 32 with the cathode gas diffusion layer 31 interposed therebetween. A gas (oxygen) is supplied to the cathode separator 20 from an upstream cathode gas manifold inlet (not illustrated), flows into the cathode gas diffusion layer 31 while circulating through the above-described passage, and a gas and water that have undergone the reaction are discharged from a cathode gas manifold outlet (not illustrated).

The amount of the catalyst metal in the cathode catalyst layer 32 of the embodiment is mainly characterized in that the amount of the catalyst metal has a distribution in the circulation direction in which the gas flows in the fuel cell. In one example, as can be seen from FIG. 8A, the amount of the catalyst metal in the cathode catalyst layer 32 is smaller in a downstream region DA located downstream of the passage than in an upstream region UA located upstream of the passage in the gas circulation direction (Y direction).

In one example, as illustrated in FIG. 8A, the amount of the catalyst metal in the cathode catalyst layer 32 may be set differently in three regions along the circulation direction that are an upstream side US having the largest amount of catalyst metal, a downstream side DS having the smallest amount of catalyst metal, and a midstream side MS having a medium amount of catalyst metal. Although the amount of the catalyst metal is set differently in three regions along the circulation direction in this example, the disclosure is not limited to this mode. The amount of the catalyst metal in the cathode catalyst layer 32 may be defined differently along the circulation direction in multiple regions other than three regions.

On the other hand, in the fuel cell 100, it may be conceivable that the power generation performance is not so high at a most upstream side MUS due to the influence of drying or the like where the cathode gas flows in. Therefore, as illustrated in FIG. 8B, the amount (supported amount) of the catalyst metal at the most upstream side MUS at a predetermined distance from the cathode gas inlet may be reduced and set to be smaller than that at the upstream side US (for example, approximately the same as that at the midstream side). As described, in the above-described circulation direction, the cathode catalyst layer 32 in the embodiment may have a region where the amount (supported amount) of the catalyst metal is smaller than a maximum value at the most upstream side MUS in consideration of the drying.

The “predetermined distance” can be set in advance by, for example, an experiment or a simulation.

As described above, also in the fuel cell 100 of the third embodiment, effects similar to those of the fuel cells 100 of the above-described embodiments can be achieved. As an example, the cathode catalyst layer 32 in the third embodiment can be manufactured by disposing a mask MK having openings op corresponding to the circulation direction with respect to the base plate 32p serving as the base material, or controlling the discharge amount of the catalyst metal liquid from the electrostatic spray.

Although the embodiments of the disclosure have been described in detail above with reference to the accompanying drawings, the disclosure is not limited to these embodiments. It is apparent that one skilled in the art to which the disclosure relates may attempt to further modify the embodiments and modifications within the scope of the technical ideas described in claims, and it is to be understood that those modifications also naturally fall within the technical scope of the disclosure.

For example, configurations of the fuel cells 100 described in the first to third embodiments may be appropriately combined. As an example, in the fuel cell 100 of the disclosure, the amount of the catalyst metal contained in the catalyst layer may be (a), in the in-plane direction of the catalyst layer, larger in the under-passage region located immediately below the passage than in the under-rib region located immediately below the ribs, and may be (b), in the circulation direction of the gas, smaller in the downstream region DA located downstream of the passage than in the upstream region UA located upstream of the passage. At this time, the amount of the catalyst metal may be (c), in the thickness direction of the catalyst layer, larger in the separator side region closer to the separator than in the electrolyte membrane side region closer to the electrolyte membrane.

In the fuel cell 100 of the disclosure, the amount of the catalyst metal contained in the catalyst layer may be (a), in the in-plane direction of the catalyst layer, larger in the under-passage region located immediately below the passage than in the under-rib region located immediately below the ribs, and may be (c), in the thickness direction of the catalyst layer, larger in the separator side region closer to the separator than in the electrolyte membrane side region closer to the electrolyte membrane.

According to the fuel cell of the disclosure, it is possible to improve power generation efficiency with respect to the amount of a catalyst metal by eliminating the waste of the catalyst that hardly contributes to power generation.

1. A fuel cell comprising:
a membrane electrode assembly in which an electrolyte membrane is sandwiched between catalyst layers; and
a separator comprising ribs that are in contact with the membrane electrode assembly and a passage that is provided between the ribs and configured to circulate a gas supplied to the electrolyte membrane, wherein
in an in-plane direction of the catalyst layers, an amount of a catalyst metal contained in the catalyst layers is larger in an under-passage region located immediately below the passage than in an under-rib region located immediately below the ribs.

2. The fuel cell according to claim 1, wherein
in a circulation direction of the gas, the amount of the catalyst metal is smaller in a downstream region located downstream of the passage than in an upstream region located upstream of the passage.

3. The fuel cell according to claim 2, wherein
in a thickness direction of the catalyst layers, the amount of the catalyst metal is larger in a separator side region closer to the separator than in an electrolyte membrane side region closer to the electrolyte membrane.

4. The fuel cell according to claim 1, wherein
in the in-plane direction of the catalyst layers, the amount of the catalyst metal is increased stepwise such that a vicinity of a center of the under-rib region has a lower limit value and a vicinity of a center of the under-passage region has an upper limit value.

5. The fuel cell according to claim 4, wherein
in the in-plane direction of the catalyst layers, the amount of the catalyst metal in a region located at a boundary between the under-rib region and the under-passage region is smaller than the amount of the catalyst metal in the vicinity of the center of the under-passage region.
